(19) United States
(12) Patent Application Publication
(10) Pub. No.: US 2020/0270160 A1
(43) Pub. Date: Aug. 27, 2020

(54) SUBMERGED COMBUSTION MELTING OF VITRIFIABLE MATERIAL

(71) Applicant: KNAUF INSULATION, Vise (BE)

(72) Inventors: Gerard DEMOTT, Majcichov (SK); Bostjan MAROLT, Poljane (SI); Randy ETZKORN, Vise (BE); David DUCARME, Wavre (BE)

(21) Appl. No.: 16/804,224

(22) Filed: Feb. 28, 2020

Related U.S. Application Data
(63) Continuation of application No. 16/699,281, filed on Nov. 29, 2019.
Application No. 16/699,281 is a continuation of application No. 16/517,563, filed on Jul. 20, 2019, now abandoned.
Application No. 16/517,563 is a continuation of application No. 16/258,787, filed on Jan. 28, 2019, now abandoned.
Application No. 16/258,787 is a continuation of application No. 14/908,757, filed on Jan. 29, 2016, now abandoned.

(30) Foreign Application Priority Data
Jul. 31, 2013 (GB) 1313653.6

(51) Int. Cl. C03B 5/235; C03B 5/12; C03B 5/44; C03B 5/225; C03B 5/237; C03B 37/01; F23C 3/00; F23D 14/20

(52) U.S. Cl. CPC C03B 5/2356; C03B 5/12; C03B 5/44; C03B 5/225; C03B 5/237; C03B 2211/70; F23C 3/004; F23D 14/20; Y02P 40/53; C03B 2211/22; C03B 37/01

(57) ABSTRACT

The present invention relates to a process for producing a boron containing glass, comprising melting raw materials including boron compounds in a submerged combustion melter (11), withdrawing flue gases from said melter and recovering heat from said flue gases in appropriate heat recovery equipment prior to release into the environment.

### CROSS-REFERENCE TO RELATED APPLICATIONS

This application is a continuation of U.S. application Ser. No. 16/699,281, filed Nov. 29, 2019, which is a continuation of U.S. application Ser. No. 16/517,563, filed Jul. 20, 2019, which is a continuation of U.S. application Ser. No. 16/258,787 (now abandoned), filed Jan. 28, 2019, which is a continuation of U.S. application Ser. No. 14/908,757 (now abandoned), filed Jan. 29, 2016, which is a U.S. national counterpart application under 35 U.S.C. § 371 of International Application Serial No. PCT/EP2014/066440, filed Jul. 30, 2014, which claims priority to GB application Ser. No. 1313653.6, filed Jul. 31, 2013, the entire disclosures of which are expressly incorporated by reference herein.

### FIELD OF THE INVENTION

The present invention relates to an improved process for melting vitrifiable material, for example a glass melting process upstream of a glass forming operation.

### BACKGROUND

In glass manufacturing, raw materials comprising, for example silica, basalt, limestone and soda ash, are brought into a melter and melted into a viscous liquid state at temperatures in the order of 1250-1550 ° C.; the melt is then supplied to downstream forming operations. Depending on the intended use of the glass melt, such as for example flat glass, hollow glass or fiber production, a refining step may be required prior to the forming operations.

Conventional glass melters comprise energy supplied from above the glass melt surface, for example by burners generating a flame in a space between the glass melt surface and a crown of the melter, whereby heat is transferred to the glass melt by radiation from the flame and from the crown material. Raw material is loaded on top of the glass melt and heat is transferred from the melt to the raw material which is then incorporated into the melt.

In a submerged combustion type melter fuel gas and oxygen containing gas (and/or combustion products thereof) pass through the mass of molten material; combustion and/or passage of hot combustion gasses through said mass heats the melt and melts raw materials. Passage through the molten mass provokes a state of agitation in the melt, that is a bubbly mass. The heat transmission is thus significant and the stirring of the bath is favorable to the homogeneity of the finished product.

Boron oxide may be included in vitreous compositions, for example to reduce the viscosity of the melt and/or the liquidus temperature and/or to improve thermal resistance and/or bio-solubility of glass fibers manufactured from the melt. Boron emissions to the environment are nevertheless undesirable. Furthermore, boron content in effluent gas has a tendency to corrode downstream equipment, such as heat exchangers, and may provoke deposits which obstruct downstream conduits.

### OBJECTS OF THE INVENTION

One of the objects of the invention is to provide a glass manufacturing process, more specifically for the manufacture of mineral fibers, notably glass fibers, glass wool and stone wool, which allows for desirable boron content in the mineral fibers while reducing difficulties and/or expense for effluent gas treatments that seek to remove boron compounds from the melter effluent gas.

Further objects will become apparent from the description here below.

### BRIEF DESCRIPTION OF THE DRAWINGS

FIG. 1 is a schematic representation of a toroidal flow pattern;

FIG. 2 shows a vertical section through a melter; and

FIG. 3 is a schematic representation of a burner layout.

### DETAILED DESCRIPTION

It has now been found that the investment for effluent gas treatment seeking to remove boron compounds from melter effluent gas can be reduced or completely omitted when boron containing glass is melted in a submerged combustion melter, notably in a submerged combustion melter having one or more of the features as described herein. It appears that such submerged combustion melting allows capture of at least the majority of potentially volatile boron compounds in the glass melt, thus significantly reducing the amount of volatile boron compounds entrained into the effluent gas. Said effluent gas may be used to preheat raw material and/or fuel gas and/or oxygen containing gas for submerged combustion in the submerged combustion melter and/or passed through a heat exchanger, without elimination of volatile boron compounds upstream of heat recovery or heat transfer equipment.

The present invention thus provides for an improved process for producing a boron containing glass, comprising melting raw materials including boron compounds in a submerged combustion melter, withdrawing flue gases from said melter and recovering heat from said flue gases in heat recovery equipment prior to release into the environment.

It has surprisingly been found that when melting mineral compositions comprising boron compounds in a submerged combustion melter, the effluent gases show a reduced content of boron compounds. The invention thus allows melting of a boron containing glass without the need for any particular gas treatment to remove boron compounds, particularly if the boron content expressed as B203 in the glass melt is comprised between 2 and 15 w %. The investment in effluent gas treatment may thus be reduced.

The glass melt may be withdrawn from the submerged combustion melter and led to a refining step and subsequent glass forming step, for example for formation of flat glass or glass containers or glass fibers. In a preferred embodiment, the melt produced is transferred to a mineral fiber production unit, preferably without any intermediate refining step, most preferably a production unit for production of mineral wool intended for insulation products.

Preferably the melter comprises a melting chamber equipped with submerged combustion burners, a raw material feeder and a melt outlet. The submerged combustion burners may be arranged in a substantially annular burner zone, preferably on a substantially circular burner line, at the bottom of the said melting chamber, at a distance between adjacent burners and controlled in such a way that flames do not merge, and oriented in a substantially vertical upright or slightly outwardly or inwardly oriented burner orientation. It has been found that such an arrangement allows generation of a toroidal convective melt flow pattern having a substantially vertical central axis of revolution, in which melt is ascending substantially over and/or adjacent burners and converging inwardly towards a central axis of revolution at the melt surface and downwardly in the center, and favors homogeneity of the melt in terms of temperature profile and composition and simultaneously captures into the melt boron compounds which would otherwise be present in flue gases. The distance between burners may vary as a function of burner design, operating pressure and other parameters. It should be noted however that too a small distance between burners may lead to fusion of flames, a phenomenon that should be avoided.

Preferably, adjacent burners are arranged at a distance between burners of about 250-1250, or about 500-900 mm, preferably about 600-800 mm, even more preferably about 650-750 mm.

The burners may be arranged at a distance of about 250-750 mm from the side wall of said melting chamber; this favors the flow described above and avoids flame attraction to the melter side walls. Too small a distance between burners and side wall may damage or unnecessarily stress the side wall. While a certain melt flow between burner and wall may not harm or may even be desirable, in order to avoid buildup of too large layer of solidified material on the walls, too a large distance will generate undesirable melt flows and may be the cause for dead zones which mix less with the melt in the center of the melter and hence lead to reduced homogeneity of the melt.

It has been found advantageous to select a burner circle diameter between about 1200 and 2000 mm. Depending on burner type, operating pressure and other parameters, too large a diameter will lead to diverging flames; too narrow a diameter will lead to merging flames.

At least 5 burners may be arranged within the burner zone, more preferably 6 to 10 or even more preferably 6 to 8 burners, depending on the burner dimensions, operating pressure and other design parameters.

For the sake of clarity, by toroidal flow pattern it is meant that the speed vectors of the moving fluid material, notably generated by simulation by means of Computational Fluid

Dynamics analysis, form a circulation pattern in which they fill cross-sections of a toroid which has as its central axis of revolution the vertical axis passing through the center of the substantially circular burner zone and as outer diameter approximately the outer diameter of said circular burner zone, with material flowing from the outside to the center at the melt surface. Preferably the fluid dynamics model code is ANSYS R14.5, taking into consideration the multi-phase flow field with phases ranging from solid batch material to liquid melt, to various gas species associated with both the combustion of fuel and oxidant by the burners as well as those generated in the course of the batch-to-melt conversion process.

The raw material may be fed above the melt surface. Advantageously, the raw material is loaded through an opening provided in the melter wall, above the melt surface. Said opening is advantageously adapted to be opened and closed, for example by a piston, in order to avoid escape of heat and fumes through the feeder. Raw material may be prepared for the relevant melt to be obtained and loaded into an intermediate chute. When the opening through the melter wall is opened, the material falls into the melter, in an opposite direction to any escaping fumes and falls onto the melt surface. The preferred flow pattern allows for efficient absorption of raw material into the melt, efficient heat transfer to the fresh raw materials and reduced emissions of volatile boron compounds.

The melting chamber is preferably substantially cylindrical; alternatively, it may have an elliptical cross section or polygonal cross section having more than 4 sides, preferably more than 5 sides.

The height of a melt pool within the melter, especially when the melter is substantially cylindrical, preferably with an internal diameter of the melting chamber of 1.5 m to 3 m and more preferably of 1.75-2.25 m, may be:
≥about 0.75 m, ≥about 0.8 m, ≥about 0.85 m or ≥about 0.9 m; and/or
≤about 2.2 m, ≤about 2 m, ≤about 1.8 m, or ≤about 1.6 m.

Melt may be withdrawn continuously or batch wise, for example from a position at or towards the bottom of the melter. When raw material is loaded close to the melter wall, the melt outlet is preferably arranged opposite the material inlet. In the case of discontinuous discharge of melt, a discharge hole may be controlled by a valve, for example a ceramic piston.

The submerged burners preferably inject high pressure jets into the melt sufficient to overcome the liquid pressure and to create forced upward travel of flames and combustion products. The speed of the combustion and/or combustible gases, notably at the exit from the burner nozzle(s), may be ≥60 m/s, ≥100 m/s or ≥120 m/s and/or ≤350 m/s, ≤330 m/s, ≤300 or ≤200 m/s. Preferably the speed of the combustion gases is in the range of about 60 to 300 m/s, preferably 100 to 200, more preferably 110 to 160 m/s.

Preferably, the melting chamber walls comprise double steel walls separated by circulating cooling liquid, preferably water. Particularly in the case of a cylindrical melting chamber, such assembly is relatively easy to build and is capable of resisting high mechanical stresses. A cylindrical shape of the melter allows for a balance of stress on the outside wall. As the walls are cooled, for example water cooled, melt preferably solidifies and forms a protective layer on the inside of the melter wall. Such melter assembly does not require any internal refractory lining and therefore needs less or less costly maintenance. In addition, the melt is not contaminated with undesirable components of refractory material eroded from an internal refractory lining. The internal face of the melter wall may advantageously be equipped with tabs or pastilles or other small elements projecting towards the inside of the melter. These may help constituting and fixing a layer or lining of solidified melt on the internal melter wall generating a thermal resistance and reducing the transfer of heat to the cooling liquid in the double walls of the melter.

The melt within the melter during operation may reach a temperature, notable a temperature at which it is removed from the melter, which is at least 1100° C., at least 1200° C. or at least 1250° C. and which may be no more than 1650 ° C., no more than 1600° C., no more than 1500° C. or no more than 1450° C.

The composition of the glass produced may comprise one or more of:

| | Possible melt | Preferred melt |
|---|---|---|
| | composition | composition |
| | (% weight) | (% weight) |
| SiO₂ | 35-70 | 40-65 |
| Al₂0₃ | 5-30 | 15-25 |
| CaO | 5-20 | 5-12 |
| MgO | 0-10 | 1-7 |
| Na₂O | 0-20 | 5-18 |
| K2O | 0-15 | 0-10 |
| Fe₂O₃ (total iron) | 0-15 | 0.5-10 |
| B₂O₃ | 1-20 | 2-15 |
| TiO₂ | 0-5 | 0-2 |
| P₂O₅ | 0-3 | 0-2 |
| MnO | 0-3 | 0-2 |
| Na₂O + K₂O | 5-30 | 5-20 |
| (alkali metal oxide) | | |
| CaO + MgO | 5-30 | 5-20 |
| (alkaline earth | | |
| metal oxide) | | |
| Si02 + Al2O3 | 50-85 | 60-80 |

The boron content of the glass produced expressed as B2O3 may be ≥1 w %, ≥2 w %, ≥3w %, ≥5w % and/or ≤20%, ≤18%, <15% or ≤10 w %.

One or more aspects described in the following patent applications, which also relate to submerged combustion melting and/or melters, may be used in respect of the inventions of the present patent application and each of the following patent applications is hereby incorporated by reference:

| | Name of | Priority | Our |
|---|---|---|---|
| Application | applicant | claimed | ref |
| International PCT | Knauf | GB 1313656.9 | P0554/PCT |
| patent application | Insulation | | KMScrap |
| PCT/EP2014/066441 | | | |
| filed on 30 Jul. 2014 | | | |
| International PCT | Knauf | GB 1313652.8 | P0523/PCT |
| patent application | Insulation | | KMburn |
| PCT/EP2014/066442 | | | |
| filed on 30 Jul. 2014 | | | |
| International PCT | Knauf | GB 1313654.4 | P0543/PCT |
| patent application | Insulation | | KMGeo |
| PCT/EP2014/066443 | | | |
| filed on 30 Jul. 2014 | | | |
| International PCT | Knauf | GB 1313651.0 | P0522/PCT |
| patent application | Insulation | | KMMod |
| PCT/EP2014/066444 | | | |
| filed on 30 Jul. 2014 | | | |

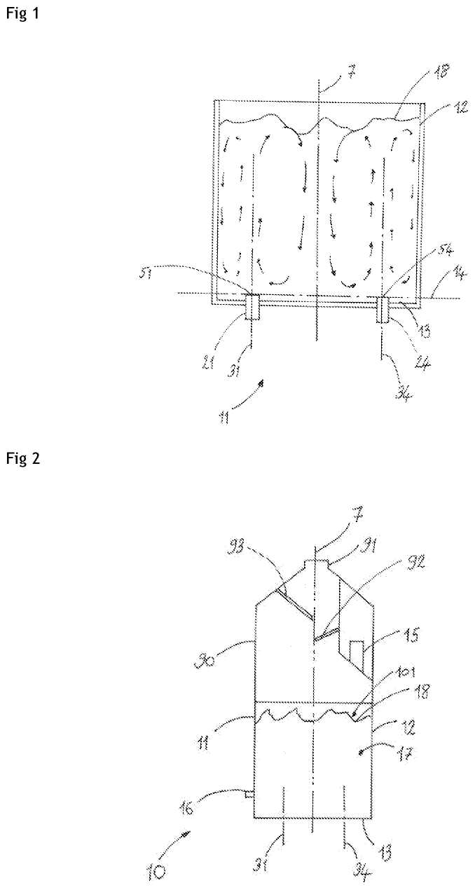

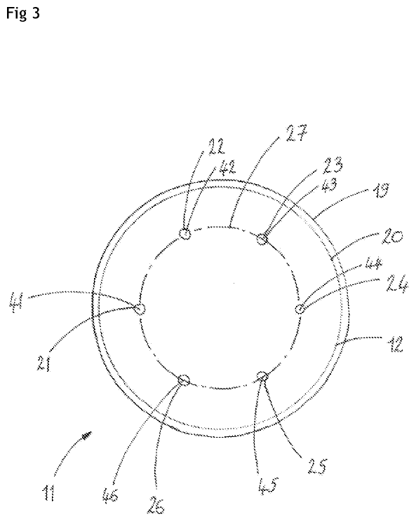

An embodiment of the present invention will be described in more details below, with reference to the appended drawings of which:
FIG. 1 is a schematic representation of a toroidal flow pattern;
FIG. 2 shows a vertical section through a melter; and
FIG. 3 is a schematic representation of a burner layout.

A melter 10 comprises: a cylindrical melting chamber 11 having a bottom 13 and a diameter of about 2.0 m which contains a melt; an upper chamber 90; and a chimney 91 for evacuation of fumes. The upper chamber 90 is equipped with baffles 92, 93 that prevent melt projections thrown from a surface of the melt being entrained into the fumes. A raw material feeder 15 is arranged at the level of the upper chamber 90 and is designed to load fresh raw material into the melter 10 at a point 101 located above the melt surface 18 and close to the side wall of the melter. The feeder 15 comprises a horizontal feeding means, for example a feed screw (not shown), which transports the raw material mix to a hopper fastened to the melter 10, the bottom of which may be opened by a vertical piston as required by the control of the melter operation. The bottom of the melting chamber 11 comprises submerged burners 21,22,23,24,25,26, each having a central burner axis 31,32,33,34,35,36 and nozzles 41,42,43,44,45,46, arranged on a circular burner line 27 concentric with the melter axis of symmetry 7 and having a diameter of about 1.4 m. The burner layout is schematically represented in FIG. 3. For the sake of clarity, the design represented in the figures has a preferred layout with six submerged burners distributed over the burner line 27. Different layouts are possible depending on the dimensions of the melter, the viscosity of the melt 17 and the characteristics of the burners. It is preferred that the flames do not merge and that the arrangement generates a toroidal melt flow as defined above. The melt may be withdrawn from the melting chamber through a controllable outlet opening 16 located in the melting chamber side wall, close to the melter bottom, substantially opposite the feeding device 15.

The melting chamber wall is a double steel wall cooled by a cooling liquid, preferably water. Cooling water connections provided at the external melter wall allow a flow sufficient to withdraw energy from the inside wall such that melt can solidify on the internal wall and the cooling liquid, here water, does not boil.

The melter represented in the figures is substantially cylindrical. Submerged combustion may generate high stress components that act on the melter walls and/or heavy vibrations. These may be significantly reduced in the case of a cylindrical melting chamber. If so desired, the melter may further be mounted on dampers which are designed to absorb most of the vibrational movements.

The submerged burners are operated at gas flow or speed of 100 to 200 m/s, preferably 110 to 160 m/s and generate combustion of fuel gas and air and/or oxygen within the melt. The combustion and combustion gases then generate flows within the melt before they escape into the upper chamber and then through the chimney. These hot gases incorporate a high level of thermal energy at least a portion of which, preferably at least 15%, 20%, 25% 30% 40% or 50%, is recovered notably in a heat exchanger. The fumes are generally filtered prior to release to the environment to remove particulates but do not require treatment to remove boron compounds.

The burners generate an ascending movement of melt in their proximity and a convective circulation within the melt. The arrangement of the burners in an annular burner zone, preferably on a circular burner line 27, in the bottom of the melting chamber 11, is capable of generating the toroidal movement explained above.

1. A process for producing a boron containing glass, comprising melting raw materials including boron compounds in a submerged combustion melter (10), the boron content of the glass melt expressed as B₂O₃ being greater than 2 w % and up to 15 w %, withdrawing flue gases from said melter and recovering heat from said flue gases in heat recovery equipment prior to release into the environment, the boron content of the glass expressed as B₂O₃ being ≥2 w % and ≤15 w %.

2. (canceled)

3. The process of claim 1 wherein the glass melt is withdrawn from the submerged combustion melter and led to a refining step and subsequent glass forming step, said glass forming step comprising the formation of flat glass, glass containers, glass fibers or continuous glass fibers.

4. The process of claim 1 wherein the glass melt is withdrawn from the submerged combustion melter and transferred to a glass fiber production unit, without any intermediate refining step, for production of mineral wool fibers selected from glass wool fibers and stone wool fibers.

5. The process of claim 1 wherein the submerged combustion melter (10) comprises a melting chamber (11) equipped with submerged combustion burners (21,22,23,24,25,26), a raw material feeder (15) and a melt outlet (16), the submerged combustion burners being arranged in a substantially annular burner zone on a substantially circular burner line (27), through the bottom (13) of the said melting chamber, at a distance between adjacent burners and controlled in such a way that flames do not merge, and said burners having a central burner axis (31,32,33,34,35,36) oriented in an substantially vertical upright or slightly outwardly oriented burner orientation.

6. The process of claim 5 wherein adjacent melter burners (21, 22, 23, 24, 25, 26) are arranged at a distance of about 250-1250 mm, or about 500-900 mm, or about 600-800 mm, or about 650-750 mm.

7. The process of claim 5 wherein the burners (21, 22, 23, 24, 25, 26) are arranged at a distance of about 250-500 mm from the side wall of said melting chamber.

8. The process of claim 5 wherein the burner circle diameter (27) is comprised between about 1200 and 2000 mm.

9. The process of claim 5 wherein at least 5 burners (21, 22, 23, 24, 25, 26), or 6 to 10 burners, or 6 to 8 burners are arranged within the burner zone.

10. The process of claim 5 wherein the cross section of the melting chamber (11) is selected from a substantially cylindrical cross section, an elliptical cross section and a polygonal cross section having more than 4 sides, or more than 5 sides.

11. The process of claim 1 wherein the submerged burners (21, 22, 23, 24, 25, 26) inject high pressure jets of the combustion products into the melt, with the combustion gases having a velocity in the range of about 60 to 300 m/s, about 100 to 200 m/s, or about 110 to 160 m/s.

12. The process of claim 5 wherein the melting chamber walls comprise double steel walls separated by circulating cooling liquid, the internal face of the melter wall being optionally equipped with tabs or pastilles or other small elements projecting towards the inside of the melter.

13. The process of claim 1 wherein heat is recovered from the flue gases in a heat exchanger without prior reduction in the boron content of the flue gases.

14. The process of claim 1 wherein recovery of heat from the flue gases comprises transferring heat energy from the flue gases to a heat exchanger fluid.

15. A method of recovering energy from flue gases produced when melting a boron containing glass, comprising withdrawing flue gases from a submerged combustion melter and recovering heat from said flue gases, wherein no elimination of volatile boron compounds takes place upstream of heat recovery or heat transfer equipment.
